(19) United States
(12) Patent Application Publication
(10) Pub. No.: US 2008/0100916 A1
(43) Pub. Date: May 1, 2008

(54) Mirror display

(76) Inventor: Rachael Lydia Suhl, Sutton, MA (US)

Correspondence Address: David Suhl, 91 Lincoln Road, Sutton, MA, 01590, US

(21) Appl. No.: 11/589,524

(22) Filed: Oct. 30, 2006

(51) Int. Cl. G02B 27/00

(52) U.S. Cl. 359/601

(57) ABSTRACT

An apparatus and method is presented enabling a visual display, for example a handheld wireless communications device such as a cell phone, to become a mirror when the display is in an off mode. The method may be used with a variety of visual displays, including electroluminescent devices (ELD), liquid crystals devices (LCD), and thin film transistors (TFT), and may provide good mirror properties with a small loss of light transmission efficiency of the display device. The method adds a half silvered surface to form a one way mirror of the front surface of the visual display.

### TECHNICAL FIELD

This disclosure pertains to digital and analog visual displays, such as may be used in consumer oriented devices including cell phones, personal digital assistants and computer. In particular, the subject matter relates to an apparatus and method for converting visual displays into mirror surfaces during non-operational display periods.

### BACKGROUND

Consumer devices, in particular cell phones, personal digital assistants (PDA) such as the Palm Pilot™, laptop computers, handheld calculators, global positioning systems (GPS), watches, handheld games and other mobile electronic devices, are typically energy consumption sensitive, since they operate on battery power. One of the most power-consuming portions of the various mobile electronic devices is the display, and thus many such devices have an operating mode, which may be known as sleep mode, whereby the display is blanked out during time periods that the display is not needed.

Displays may use various low power consuming methods, such as liquid crystal displays (LCD), thin film transistor (TFT) displays, digital light transmission (DLT) displays, or field emission (FE) devices similar to a cathode ray tube (CRT) display with an array of cold cathode emission points located behind a phosphor electroluminescent display screen. In general, these various types of low power displays may be known as flat panel displays, and may be provided in color or in black and white versions, may have different resolution values and different image retention times. In each case, the display may include a flat front surface, which may be referred herein as a plate, typically formed of glass or plastic, and an illuminated area behind the front surface. that structural, mechanical, logical and electrical changes may be made without departing from the scope of the present subject matter. The following detailed description is, therefore, not to be taken in a limiting sense, and the scope of the present subject matter is defined by the appended claims and their equivalents.

In general, what is needed is a method of allowing a visual display to be converted into an efficient mirror during time periods when the visual display is not needed for active data and image transmission. As an illustrative example, the front plate of an electronic device's display may be formed of a flat transparent plastic material. The front plate does not have to be flat, but may rather be convex or concave, to magnify or reduce the size of the displayed image. The front plate may not be totally transparent, but rather may be slightly translucent or have a slightly roughened front surface, sometimes known as a matte surface, to reduce glare from light sources outside the visual display system.

Whether the display system is an LCD, a FE device such as an electroluminescent system, or other type of display system, the transparent front plate must provide for efficient light transmission, at least for photons generated directly below any particular portion of the front plate. In other words, the light generated at a location perpendicular to any specific portion of the front plate should beneficially have a high transmission coefficient through the transparent front plate. The area controlled by a single display data point, known as a picture element or pixel, is the smallest portion of the display that can be varied independent of the other pixels in the display device. For example, a standard definition television display may have an array of pixels of 320 by 525. Light generated at locations not directly perpendicular and below the specific portion of front plate may be beneficially reflected back into the display system interior to prevent smearing, or loss of resolution, of the image due to unintended illumination from pixels next to the intended pixel.

The illuminated area behind the front plate may be a general light source that is locally blocked by a liquid crystal cell to form dark characters (letters, numbers, and images) in the light flowing through the clear front plate. In an electroluminescence display, an array of emitters provides electrons in selected regions, which strike various colored phosphors located substantially directly in front of the emitters, to provide a local burst of light and/or color that flows through the clear front plate to form an image. The image is formed by light transmitted from a region behind the front plate, through the transparent plate to the viewer.

### BRIEF DESCRIPTION OF THE DRAWINGS

FIG. 1 illustrates a prior art example of a single picture element in a display in an active mode;

FIG. 2 illustrates a cross sectional view of a single picture element in a display according to one embodiment of the present subject matter;

FIG. 3 illustrates a cross sectional view of a single picture element in a display according to another embodiment of the present subject matter;

FIG. 4 illustrates a cross sectional view of a single picture element in a display according to a third embodiment of the present subject matter; and

FIG. 5 illustrates a cross sectional view of a single picture element in a display according to a fourth embodiment of the present subject matter.

### DETAILED DESCRIPTION

In the following detailed description, reference is made to the accompanying drawings that form a part hereof, and in which is shown, by way of illustration, specific embodiments in which the present subject matter may be practiced. In the drawings, similar portions of each drawing have similar identifying numerals for simplicity. These embodiments are described in sufficient detail to enable those skilled in the art to practice the subject matter, and it is understood that the embodiments may be combined, or that other embodiments may be utilized and

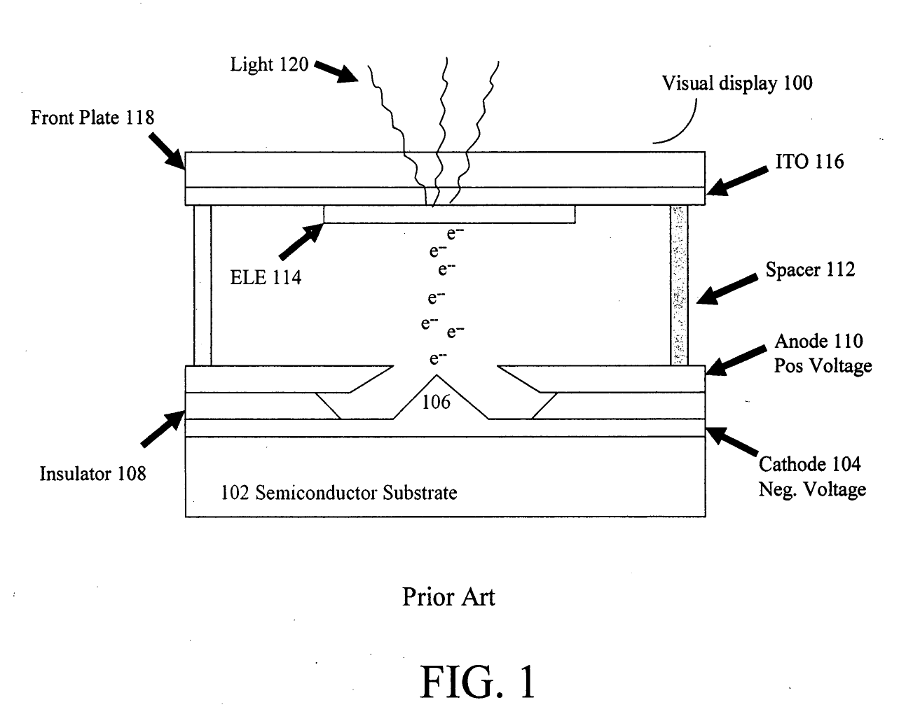

FIG. 1 illustrates a prior art example of a single picture element in a display in an active mode. The specific type of visual display shown is an electroluminescence device (i.e., ELD), and a single picture element (i.e., a pixel) is shown, but the disclosed embodiments are not so limited. In this general type of visual display there are two main portions, an electronic device that may controllably turn a particular pixel on and off to emit a stream of electrons, and an electroluminescent element (i.e., an ELE) that converts the emitted electrons into light waves. The resolution of the visual display 100 may be measured in various ways, including the number of pixels per centimeter. In addition to simply turning the device on and off, the pixel may have intensity variations, which may be known as a gray scale. The intensity may be adjusted by controlling the voltage across the cathode 104 and the anode 110, as may be seen in FIG. 1, or by the use of a duty cycle, in which the pixel is turned on for fractions of a second, and left off for the remaining time periods. A pixel that is always on is said to have a 100% duty cycle, while a pixel that is on for one millisecond and off for 999 milliseconds, has a 0.1% duty cycle, and will appear dimmer than a pixel with a larger duty cycle. The number of different illumination levels may be controlled by a binary value of a controlling circuit, and may be defined by the number of binary bits of memory necessary to detail all the possible levels. For example, an eight bit memory word might control two to the eighth power, or 256 different digital illumination levels. In addition, each pixel may have a different color from surrounding pixels in a color display. Typical displays may have red, green and blue pixels.

The illustrative pixel in the visual display 100 consists essentially of a semiconductor substrate 102, which may contain electronic devices (not shown for simplicity) that control the on and off time periods of each individual pixel, as well as the intensity level of each pixel at each point in time. The substrate 102 may have a dielectric layer (not shown) to insulate the majority of the substrate from the conductive cathode, and to electrically isolate each individual pixel from the other surrounding pixels to prevent image blurring and degradation.

The substrate 102 may have a cathode 104 formed over selected portions, typically in the form of a rectangular array of pixels. Better resolution may be obtained by forming the pixels as small as possible consistent with minimizing what may be referred to as cross talk between pixels. The cathode 104 may be formed of a conductive material that is easily stripped of electrons by imposing a negative voltage on the cathode. The electric field required to cause electrons to leave the cathode conductor 104 is a function of the material used and the distance to the anode (i.e., the positive electrode) as well as the impressed voltage. To increase the electric field without increasing the impressed voltage, it is known to form sharp points 106, which may be called asperities or peaks, to concentrate the electric field, and to more sharply focus the electron beam.

The cathode 104 may be formed of various types of conductive materials, such as metals and doped polycrystalline silicon. In either case, the conductive cathode 104 will have an insulator material 108, grown by oxidization, or deposited by physical or chemical vapor deposition processes, located on the top surface to insulate the cathode 104 from the positively charged anode 110. The insulator provides electrical isolation between the cathode 104 and the anode 110 to support the electric field formed by the different voltages applied to the cathode and anode. The thickness of the insulator 108 and its dielectric constant influence the electric field strength and the number of electrons removed from the cathode peak 106, and thus the brightness of the display pixel 100 at a selected applied voltage.

The electrons forced off of the cathode 104 by the negative voltage applied to the cathode, are accelerated away from the cathode by the positive voltage of the anode 110. The electrons continue on to the region beyond the anode, which is held at a selected distance from the electroluminescent portion of the device by spacers 112. While the spacers 112 are shown as surrounding the pixel 100, other arrangements exist and may have different benefits, advantages and issues. The spacers keep the bottom portion of the visual display 100 at a fixed location relative to the top portion. The electrons, after leaving the cathode 104 and passing the anode 110, travel to the electroluminescent element (ELE) 114, and create light waves 120 that travel through the indium tin oxide (ITO) 116 layer and the front plate 118 to form the image, with light emitted by numerous other pixels.

The ITO layer 116 is a conductive and transparent material that may be more positively charged than the anode 110 to increase the brightness of the visual display pixel 100 by increasing the number and energy of the electrons striking the ELE 114. The interface between the ELE 114 and the ITO 116 is beneficially smooth to allow for maximum light transmission, but some generated light waves in the ELE 114 may travel at an angle to the ITO that exceeds the critical angle for internal reflection, resulting in a loss of light intensity being emitted by the pixel 100, and creating a potential light blurring problem in an adjacent pixel if the light waves bounce around enough in the space between the top and bottom portions of the device to be transmitted to the outside at a different pixel location. The layer of ITO may not be present in all electroluminescent devices, but the internal reflection of light generated in other pixels may occur from internal reflection at the front plate 118 interface. It is known to reduce the amount of internal reflection that occurs by coating the front plate 118 with a material that has an index of refraction that is between the index of the front plate and the ELE 114 or the interior of the pixel. Alternatively, the coating may be formed to have a thickness such that destructive wave interference occurs between the outgoing and reflected waves. Such a coating may be known as a quarter wave coating or an anti-reflection coating (ARC), and are known to be used in optical equipment, such as binoculars, microscopes and telescopes. Materials that are known to act as anti-reflection coatings include silicon oxides such as glass, fused silica and quartz, silicon nitrides, silicon oxynitrides, aluminum oxides, and various ionic materials such as lithium fluoride. The top surface of the front plate 218 may have a non-smooth surface, which may be known as a matte finish, to help reduce external glare.

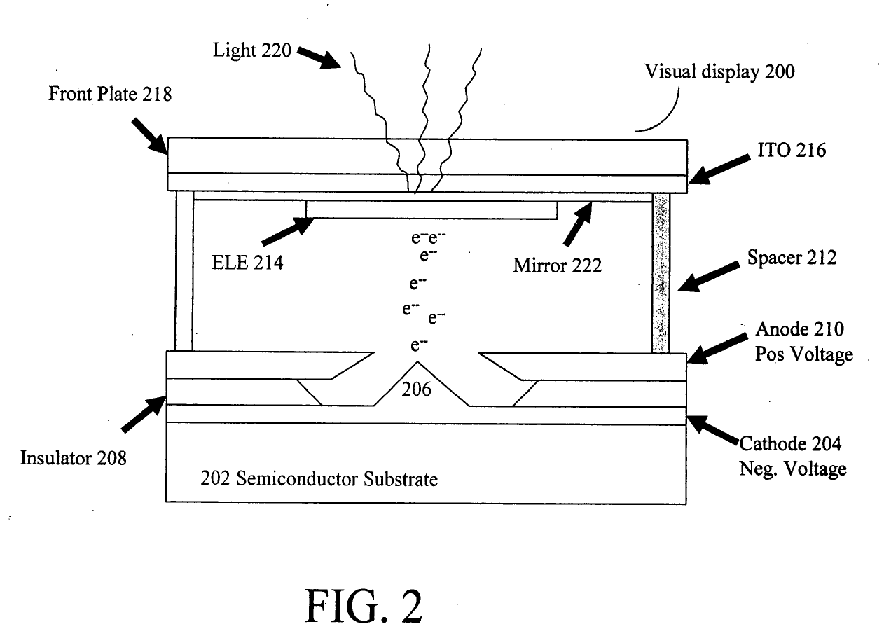

FIG. 2 illustrates a cross sectional view of a single picture element in a display according to one embodiment of the present subject matter. The elements of the illustrative embodiment of a electroluminescent device 200 pixel have similar numbers to similar portions of the prior art device in FIG. 1, and differ primarily in the addition of a mirror layer 222 placed between the ELE 214 and the ITO 216. The mirror layer 222 may be what is known as a one way mirror, or a half coated mirror, and comprise a very thin layer of a reflective material. For example, the reflecting layer may be formed of aluminum, with a thickness that is less than what may be known as the skin depth of the material. Such a thin layer may be adjusted to allow a desired percentage of the incident light to pass through. When the cathode 204 is emitting electrons to strike the ELE 214, there will be a substantial number of photons of light 220 produced, and with a thin enough half mirror layer 222, the great majority of the photons will pass through the ITO 216 layer and the front plate layer 218 to form part of the image. On the other hand, during time periods when the cathode 204 is not emitting electrons, the region between the anode 210 and the front plate 218 will be dark and there will be few photons of light 220 produced. In this situation, the majority of the light from the external area beyond the top surface of the front plate will either reflect back from the top surface of the front plate 218 (as occurs with the situation of a lighted room reflected in the window looking out over a dark night) or from the ITO layer, but the great majority of the light will reflect from the half mirror layer 222, as occurs with what are known as one way mirrors. Thus, the visual display 200 becomes an improved mirror when there is no image projected.

The mirror layer 222 should have a thickness determined by the specific allowable loss of display intensity due to photons of light 220 lost in the mirror layer 222, as compared to the desired improvement in the front plate 218 mirror properties. The mirror layer may be formed from a conductive material, and so may be used as the electron attracting positive electrode, or as an addition to the existing ITO 216 electrode.

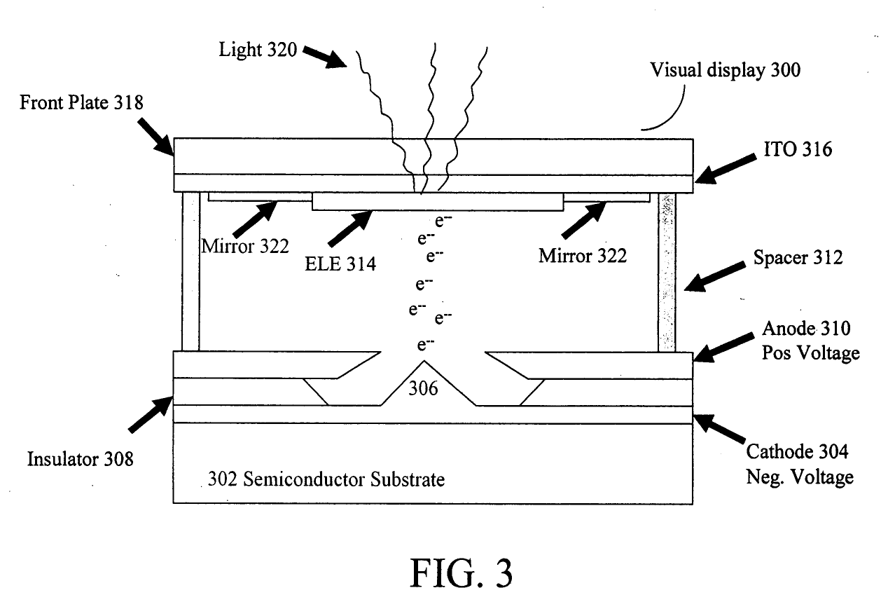

FIG. 3 illustrates a cross sectional view of a single picture element in a display according to a second illustrative embodiment of the present subject matter. In this second illustrative embodiment the mirror layer 322 is formed on the ITO 316 in regions beside the ELE 314 and not in regions between the ELE 314 and the ITO 316. This arrangement improves the overall transmission efficiency of the photons of light 320 formed in the ELE 314 as compared to the first embodiment in which some small percentage of light is reflected by the mirror layer. This arrangement reduces the reflectance of the visual display 300 since the coverage of the mirror layer is less than in prior embodiments.

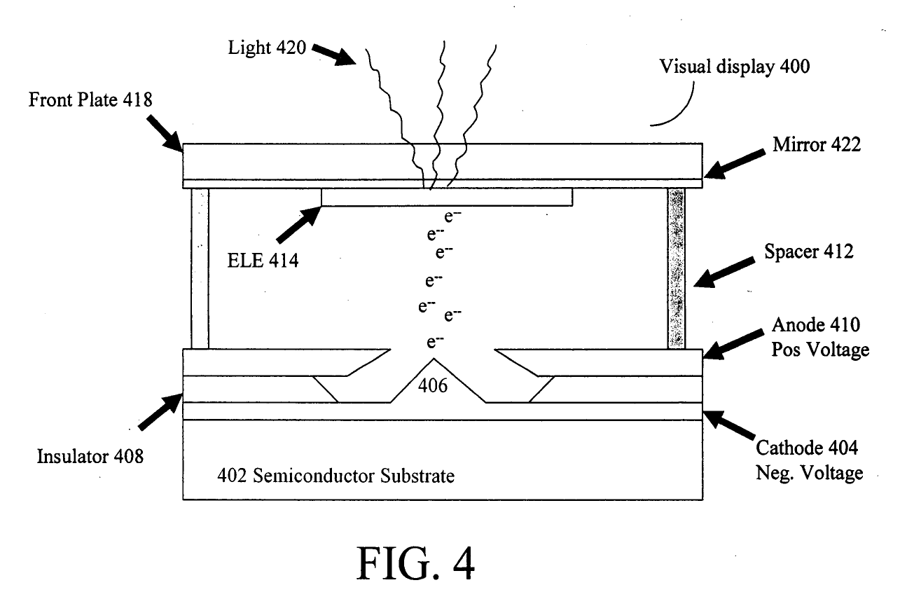

FIG. 4 illustrates a cross sectional view of a single picture element in a display according to a third embodiment of the present subject matter. In this arrangement the ITO layer is removed and the mirror layer 422 is used as the most positively charged electrode. This arrangement may reduce the cost of manufacture of visual display 400 by eliminating the ITO deposition expense, while still maintaining the illumination intensity benefit of a positive electrode in addition to the anode 410.

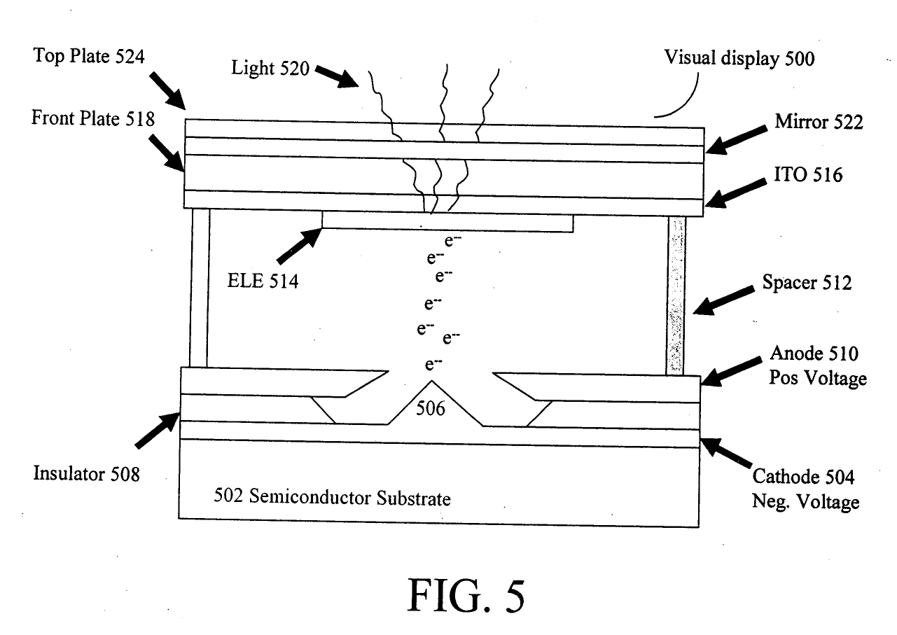

FIG. 5 illustrates a cross sectional view of a single picture element in a display according to a fourth embodiment of the present subject matter. The fourth illustrative embodiment places the mirror layer 522 on the opposite surface of the front plate 518 from the ITO electrode 516 and the ELE 514. This arrangement may allow a user of standard electroluminescent or other display technology devices to add the mirror layer 522 to finished devices. In the case where the mirror layer 522 is formed of an aluminum layer, an additional scratch and oxidation prevention film may be formed on the mirror layer. The scratch prevention layer is referred to in this disclosure as a top plate 524, but may be formed of a liquid coating, a solid sheet of transparent material, or as a flexible plastic material.

Combinations of the previously disclosed embodiments may be easily imagined. For example, the ITO 516 layer may be replaced by a mirror layer.

### CONCLUSION

The above discussed problems are addressed by a display with a front plate that is partially mirrored on either or both of the front surface and the back surface, to form a mirror during periods when the display lighting within the device is turned off. The present inventor has recognized that what is needed in the art is a display that has a dual purpose, conveying information during an active phase, and allowing undistorted reflection during an inactive phase.

In one embodiment, the display device includes a visual display set up to convey information and images during active use periods, and providing a reflected image during inactive display periods, such as a sleep state. The reflected image may typically be a standard unaltered reflection, but it is also possible to have an enlarged image for very small displays, or a reduced image, by the use of convex and concave front surfaces. Typically the display front plate is transparent to allow maximum display brightness, but may also be lightly textured to have a non reflective matte surface to reduce glare. The front plate may be formed of glass, plastic, mineral crystal or other essentially transparent materials. A reflective layer, typically a metal, may be formed on the internal surface of the front plate, with a metal thickness selected to reflect a majority of incident external light when the visual device is off and dark. This may be known as half mirroring, and the resulting device may be known as a one way mirror. While the front plate external surface is typically polished smooth, the embodiments are not so limited, and the front surface may be formed with a surface roughness sufficient to prevent glare. The visual display devices that may use the mirrored surface include electroluminescent, liquid crystal and thin film transistor displays. Whatever the type of visual device, the metal layer may typically be formed between a luminescence element and the internal surface of the front plate. Typical uses include cell phones, personal digital assistants, laptop computers, handheld calculators, games, global positioning systems, watches, radios, televisions, iPods® and other mobile electronic devices.

In another embodiment, the visual display has a semiconductor substrate, including circuits formed of semiconductor devices and dielectric layers, a conductive cathode formed on the semiconductor substrate, and a patterned insulative layer formed on the cathode which leaves a portion of the cathode uncovered to emit electrons. A patterned conductive anode is formed on the insulative layer, which is thus spaced from the cathode, and again a portion of the cathode is left uncovered to allow electrons to leave the cathode under the voltage difference of the anode to cathode. A light emitting structure is formed and held at a selected distance from the anode, where the electrons emitted by the cathode and accelerated by the anode may strike the light emitting structure, which may be formed on a conductive layer, which is itself formed on a transparent plate, or the light emitting layer may be formed directly on the transparent plate. Thus, the transparent plate transmits light formed in the light emitting structure due to the electrons emitted by the cathode when the circuits in the semiconductor substrate put the cathode and anode into an active display mode. The conductive layer may be used to increase the brightness of the display by having a positive voltage applied to attract and accelerate the electrons. Alternatively, the conductive layer may be formed of a conductor electrode and a light reflector layer. In either case the conductive layer is formed with a thickness required to reflect light during an inactive display period. This is similar to what may be known as a one way mirror, in which it appears to be a mirror when the area behind the mirror is dark, while on the dark side, the mirror appears to be a window into the lighted side.

Typically, the cathode is formed of a material that readily emits electrons when negatively charged and/or heated, and the cathode beneficially has a pointed region or peak that is directed towards the light emitting structure, since this concentrates the cathode to anode electric field and provides a preferred location for emitting electrons, as compared to having electrons emitted all over the exposed cathode surface. Typically, the conductive layer is formed of aluminum, but other materials such as silver, gold and chrome may also be used, and the layer has a thickness selected to reflect a predetermined percentage of incident light.

In another illustrative embodiment, a method for improving display reflectance includes forming a visual display with a transparent front plate, and forming a reflective material layer on either the internal surface or the external surface. If a reflective layer is formed on the external surface, a scratch and oxidation prevention coating may improve device lifetime. The reflective material layer typically includes depositing aluminum, copper, silver, gold, titanium, silicon, nickel, chromium, germanium, and various combinations. The reflective material may be formed on portions not blocking the electroluminescent material, to improve image brightness, with only a small loss of mirror quality.

The method may also include forming a cathode electrode on a substrate, forming an insulating layer on a portion of the cathode, forming an anode electrode on a portion of the insulating layer, forming a light emitting structure separated from the anode by a selected distance, forming a conductive layer on the light emitting structure, and connecting the conductive layer to a transparent plate.

The above description is intended to be illustrative, and not restrictive. Many other embodiments will be apparent to those of skill in the art upon reviewing the above description. The scope of the present disclosure should not be limited to the described embodiments, and is set forth in the following claims.

What is claimed is:

1. A device, comprising:
a visual display disposed to convey information and images during an active period; and
the visual display disposed to provide a reflected image during an inactive period.

2. The device of claim 1, wherein the reflected image is one of an enlarged image, a non-magnified image and a reduced image.

3. The device of claim 1, wherein the visual device includes a transparent front plate having an internal and an external surface, and a metal layer formed on the internal surface of the front plate, the metal layer having a thickness selected to reflect a majority of incident external light during a time period when the visual device is in an off state, while transmitting a majority of internally generated light during a time period when the visual device is in an on state.

4. The device of claim 3, wherein the front plate external surface has a surface roughness sufficient to prevent external illumination glare.

5. The device of claim 1, wherein the visual device is at least one of an electroluminescent device, a liquid crystal device and a thin film transistor device.

6. The device of claim 3, wherein the visual device is an electroluminescent device and the metal layer is formed between an electroluminescence element and the internal surface of the front plate.

7. The device of claim 1, wherein the visual device is a portion of at least one of a cell phone, a personal digital assistant, a laptop computer, a handheld calculator, a handheld game, a global positioning system, a watch, a radio, a television, an audio device and a mobile electronic device.

8. A visual display, comprising:
a semiconductor substrate including a plurality of semiconductor devices and dielectric layers;
a conductive cathode formed on the semiconductor substrate;
a patterned insulative layer formed on the cathode leaving a portion of the cathode uncovered;
a patterned conductive anode formed on the insulative layer, spaced from the cathode, and leaving a portion of the cathode uncovered;
a light emitting structure disposed at a selected distance from the anode, the light emitting structure formed on a conductive layer;
the conductive layer formed on a transparent plate and disposed to transmit light from the light emitting structure during an active display period; and
the conductive layer disposed to reflect light during an inactive display period.

9. The visual display of claim 8, wherein the cathode is formed of a material that readily emits electrons when negatively charged.

10. The visual display of claim 9, wherein the cathode has a pointed region directed towards the light emitting structure to concentrate a cathode to anode electric field and provide a preferred location for emitting electrons.

11. The visual display of claim 8, wherein the conductive layer is formed of aluminum.

12. The visual display of claim 11, wherein the conductive aluminum layer has a thickness sufficient to reflect a predetermined percentage of incident light.

13. A method for improving display reflectance, comprising:
forming a visual display including a transparent front plate having an internal and an external surface; and
forming a reflective material layer on at least one of the internal surface and the external surface.

14. The method of claim 13, wherein forming a reflective material layer includes depositing at least one of aluminum, copper, silver, gold, titanium, silicon, nickel, chromium, germanium, and combinations thereof

15. The method of claim 13, wherein forming a reflective material layer includes forming the reflective material on portions of the internal surface not proximate to an electroluminescent material.

16. The method of claim 13, further comprising a coating on a reflective material layer on the external surface of the front plate.

17. The method of claim 13, further comprising:
forming a cathode electrode on a substrate;
forming an insulating layer on a portion of the cathode;
forming an anode electrode on a portion of the insulating layer;
forming a light emitting structure separated from the anode by a selected distance;
forming a conductive layer on the light emitting structure; and
connecting the conductive layer to a transparent plate.
